(19) United States
(12) Patent Application Publication
(10) Pub. No.: US 2003/0194907 A1
(43) Pub. Date: Oct. 16, 2003

(54) Modular receptacle coupler

(76) Inventors: Raymond H. Riner, Hicksville, OH (US); Brian K. Rupert, Kendallville, IN (US)

Correspondence Address: Todd T. Taylor, TAYLOR & AUST, P.C., 142 S. Main St., P.O. Box 560, Avilla, IN, 46710, US

(21) Appl. No.: 10/120,033

(22) Filed: Apr. 10, 2002

(51) Int. Cl. H01R 13/60

(52) U.S. Cl. 439/532

(57) ABSTRACT

A modular receptacle coupler, including a housing having a first end and an opposite second end and a plurality of conductors disposed substantially within the housing, at least one of the plurality of conductors having an electrical contact proximate the first end and an other electrical contact proximate the second end.

### BACKGROUND OF THE INVENTION

1. Field of the invention.

The present invention relates to a modular electrical power distribution system, and, more particularly, to a coupler for modular electrical receptacles.

2. Description of the related art.

The modern office environment often consists of a large open area or floor space that is divided into separate and distinct work areas by way of a modular wall panel system. Modular wall panels can be moved about with relative ease, to change an entire office floor plan. Contained in the modular wall panels are modular power distribution systems, which may include a wiring harness or channel that is connected with a modular electrical device such as an electrical outlet. The wiring harness or channel typically includes a plurality of wires, which are associated with line, neutral and ground conductors of the power distribution system.

Associated with the modular power distribution system and the wiring harness are modular electrical outlets such as the one disclosed in U.S. Pat. No. 5,915,984 (Rupert et al.), which is assigned to the assignee of the present invention. The modular electrical outlet of Rupert et al. interconnects with a connector of the wiring harness of the modular power distribution system to provide power to office appliances, computers, fax machines and associated electrical equipment.

The distribution of electrical power in a modular power distribution system is accomplished by way of a plurality of connected, electrically pre-wired wiring harnesses that contain a plurality of power, neutral and ground lines. Examples may include ten wire systems that can contain such combinations as six power conductors, two neutral conductors and two ground conductors, which define six different circuits, or may include four power conductors, four neutral conductors and two ground conductors which define four different circuits. Connected to the wiring harness is a modular electrical outlet, which has a connector, associated with one end, as in the aforementioned Rupert et al. patent.

Often in a modular power distribution system there arises a need to expand the capacity and capability of the electrical outlets. This usually requires re-wiring, running new lines to the distribution system or installing new outlet assemblies.

What is needed in the art is a relatively easy way to connect modular electrical outlets in series.

What is further needed in the art is an electrical assembly, which includes a number of conductors to pass electrical power from one modular receptacle to another modular receptacle.

### SUMMARY OF THE INVENTION

The present invention provides a modular electrical receptacle coupler having a plurality of conductors, each corresponding conductor associated with a circuit.

The invention comprises, in one form thereof, a modular receptacle coupler, including a housing having a first end and an opposite second end and a plurality of conductors disposed substantially within the housing, at least one of the plurality of conductors having an electrical contact proximate the first end and an other electrical contact proximate the second end.

An advantage of the present invention is that modular receptacles may be easily connected in series.

Another advantage is that a coupler can be installed in the field without requiring an electrician to expand the number of modular receptacles in a modular power distribution system.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective, exploded view of an embodiment of a modular wall panel system including a modular receptacle coupler of the present invention;

FIG. 2 is a perspective view of the modular receptacle coupler shown in FIG. 1;

FIG. 3 is a cross-sectional view taken along 3-3 of the modular receptacle coupler of FIG. 2; and

FIG. 4 is an end view of the modular receptacle coupler of FIGS. 1-3.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

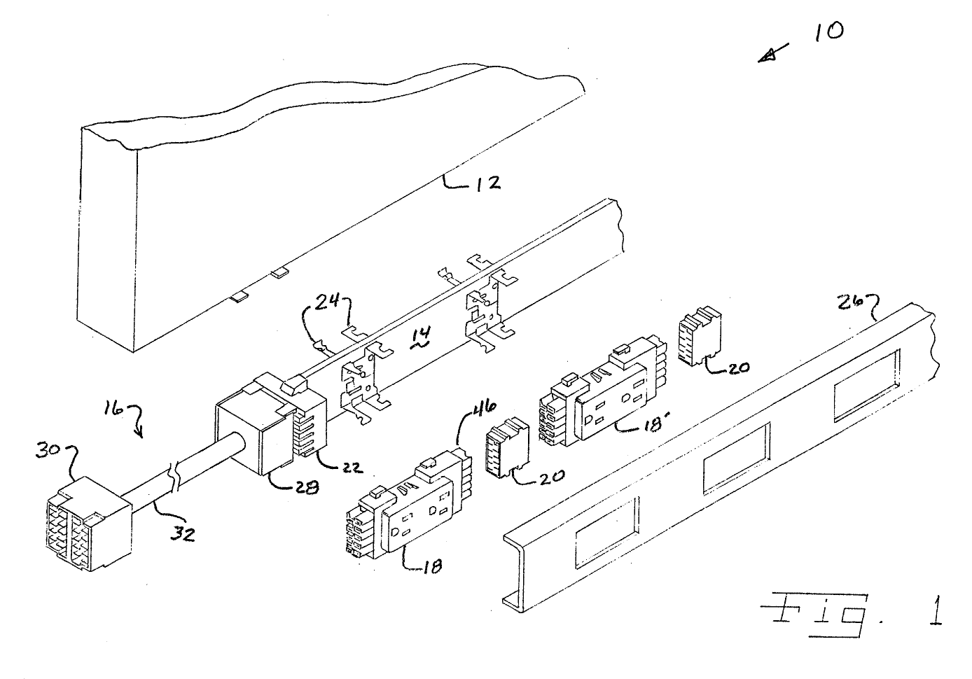

Referring now to the drawings, and more particularly to FIG. 1, there is shown an embodiment of the present invention contained in a modular panel system 10. Modular panel system 10 includes modular panel 12, wiring channel assembly 14, wiring harness assembly 16, modular receptacle 18 and module receptacle coupler 20. Modular panel system 10 is a typical system used in an office environment allowing the constructing of modules within an open area of an office floor space.

Wiring channel assembly 14 includes interface connector 22, receptacle mounting brackets 24 and cover 26. Interface connector 22 is installed as a part of wiring channel assembly 14 to provide an interface for electrical power between wiring harness assembly 16 and modular receptacle 18. Receptacle mounting brackets 24 are spaced along wiring channel assembly 14 to physically mount modular receptacles 18 thereto. Receptacle mounting brackets 24 and modular receptacles 18 and 18′ are arranged to provide complimentary locking mechanisms to attach modular receptacles 18 and 18′ to wiring channel assembly 14. Cover 26 is removably placed over wiring channel assembly 14 to provide a finished look to the modular panel system 10. Cover 26 contains holes that allow access to modular receptacles 18 and 18′.

Wiring harness assembly 16 includes first connector 28, second connector 30 and conductor harness 32. First connector 28 is electrically connected to conductors contained in conductor harness 32. First connector 28 is removably connected to interface connector 22 providing electrical power thereto. Second connector 30 interfaces with a power distribution source, either in another modular panel system 10 or a power distribution source contained in, for example, an electrical distribution box. Conductor harness 32 includes a plurality of conductors providing line, neutral and ground connections from an electrical source to modular panel system 10.

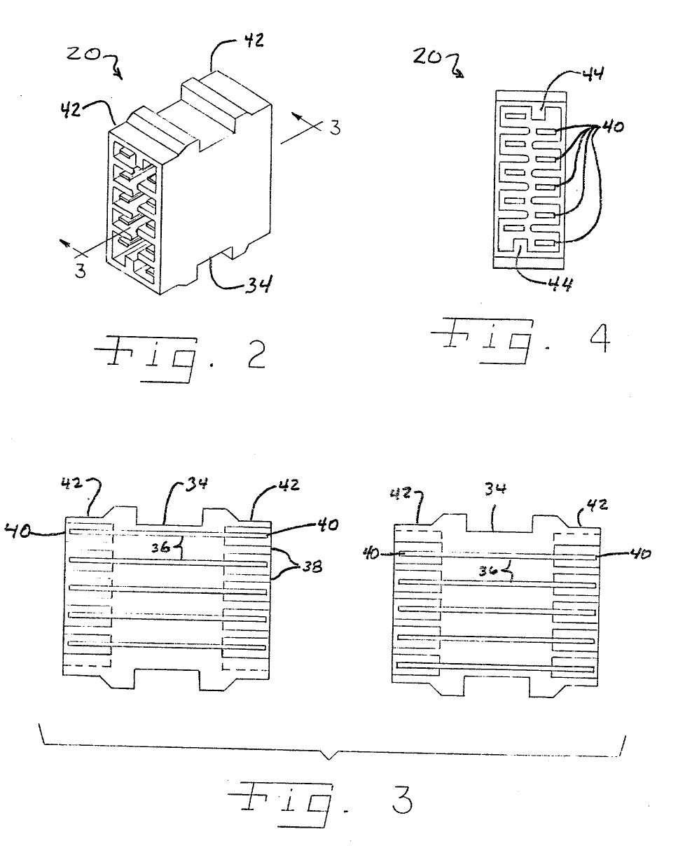

Now, additionally referring to FIGS. 2-4, there is illustrated a module receptacle coupler 20 that includes housing 34, a plurality of conductors 36, non-conductive protrusions 38, electrical contacts 40 and connectors 42. Housing 34 is made from a non-conductive material such as plastic and may be injection molded. Housing 34 consists of two parts as shown in FIG. 3, each part being identical.

Conductors 36 are positioned within housing halves 34 to provide electrical connections from one end of module receptacle coupler 20 to the other end of module receptacle coupler 20. Non-conductive protrusions 38 are positioned within housing 34 to electrically isolate each of conductors 36 from each other. Non-conductive protrusions 38 may be continuous along the length of conductors 36 or be intermittently positioned to provide the necessary electrical separation. At each end of each conductor 36 is a corresponding electrical contact 40, which is integral with conductor 36. Electrical contact 40 provides an electrical interface with connector 46 of modular receptacle 18. Alternatively, electrical contact 40 may be a separate part yet electrically connected to conductor 46 Electrical contacts 40 are arranged in an order, which is illustrated in FIG. 3, such that an electrical contact 40 of a particular conductor 36, at one end of modular receptacle coupler 20, is associated with another electrical contact 40 of the same conductor 36 at the other end of modular receptacle coupler 20. The order is such that the arrangement on one end of modular receptacle coupler 20 is the mirror image, of the order, on the other end of modular receptacle coupler 20.

Connectors 42 are disposed on each end of module receptacle coupler 20. Connectors 42 electrically separate electrical contacts 40 and secure electrical contacts 40 so that module receptacle coupler 20 can be electrically mated with connector 46 on modular receptacles 18 and 18′. Connectors 42 have keying feature 44, which corresponds to a keying feature on mateable connectors 46 on modular receptacles 18 and 18′. The corresponding keying features, of connectors 42 and connectors 46 ensure that modular receptacle 18′ will be installed with its face oriented in the same general direction as modular receptacle 18. As depicted in FIG. 4, connector 42 may have a staggered double column of electrical contacts 40.

Module receptacle coupler 20 is configured to convey multiple line voltage circuits on some of conductors 36, multiple neutral circuits on other conductors 36 and multiple ground circuits on still other conductors 36. Therein lies one of the advantages of the present invention, that all of the available circuits are serially passed from one modular receptacle 18 to another by way of module receptacle coupler 20. While the connection of module receptacles 18 and module receptacle couplers 20 is referred to as a serial connection, the electrical circuits within module receptacle 18 and module receptacle coupler 20 are conveyed as parallel circuits.

To install a module receptacle coupler 20 in modular panel system 10, which has already been installed in an office environment, cover 26 is removed thereby allowing access to a modular receptacle 18. Module receptacle coupler 20 is installed by pressing connector 42 onto mating connector 46 of modular receptacle 18. Modular receptacle 18′ is then positioned in a series-like arrangement with another end of module receptacle coupler 20 and pressed together completing the electrical connection between modular receptacle 18 and modular receptacle 18′. Modular receptacle 18′ is also secured to wiring channel assembly 14 by way of receptacle mounting brackets 24. Additional modular receptacles 18 or 18′ may be added in a series-like fashion with one module receptacle coupler 20 installed between each successive modular receptacle 18. This arrangement allows for an expansion of the number of outlets available in modular panel system 10.

Although module receptacle coupler 20 has been described as being assembled using conductor housing halves 34, alternatively, module receptacle coupler 20 may be made as one injection molded assembly. In addition, although conductors 36 have been shown and described as single solid metal conductors, conductors 36 may be wires with terminals on each end thereof or any other type of electrical conductor to which electrical contacts 40 may be electrically connected.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A modular receptacle coupler, comprising:
a housing having a first end and an opposite second end; and
a plurality of conductors disposed substantially within said housing, at least one of said plurality of conductors having an electrical contact proximate said first end and an other electrical contact proximate said second end.

2. The coupler of claim 1, wherein said electrical contacts at said first end are arranged in a first contact configuration, said electrical contacts at said second end are arranged in a second contact configuration, said plurality of conductors serially connecting an electrical contact in said first contact configuration with a corresponding electrical contact in said second contact configuration.

3. The coupler of claim 1, wherein both said first end and said second end each include an electrical connector.

4. The coupler of claim 3, wherein each of said electrical connectors is configured to connect a mateable connector of a modular receptacle.

5. The coupler of claim 3, wherein each of said electrical connectors include a keying feature.

6. The coupler of claim 1, wherein said plurality of conductors each include a first electrical contact end and a second electrical contact end, said plurality of conductors being arranged with said first electrical contact ends disposed toward said first end of said housing in an order, said second electrical contact ends being disposed toward said second end of said housing in an other order, said order and said other order being a mirror image of each other.

7. The coupler of claim 6, wherein said order includes a dual staggered column of said first electrical contact ends.

8. The coupler of claim 1, wherein said plurality of conductors are configured to convey at least one of multiple line circuits, multiple neutral circuits and multiple ground circuits.

9. A modular panel system, comprising:
a modular wall panel;
a wiring harness removably connected to said modular wall panel;
a plurality of modular receptacles, at least one of said plurality of modular receptacles is electrically engaged with said wiring harness; and
at least one module receptacle coupler, each said at least one module receptacle coupler electrically connecting two of said plurality of modular receptacles, each said module receptacle coupler, comprising:
a housing having a first end and a second end; and
a plurality of conductors disposed substantially within said housing, at least one of said plurality of conductors having an electrical contact proximate said first end and an other electrical contact proximate said second end.

10. The system of claim 9, wherein each said modular receptacle coupler has said electrical contacts associated with said first end arranged to define a first contact configuration and said electrical contacts associated with said second end arranged to define a second contact configuration, said conductors serially connecting two of said plurality of modular receptacles.

11. The system of claim 9, wherein both said first end and said second end of said module receptacle coupler each include an electrical connector.

12. The system of claim 11, wherein each of said electrical connectors is configured to engage a mateable connector of one of said plurality of said modular receptacles.

13. The system of claim 11, wherein each of said electrical connectors of said module receptacle coupler include a keying feature.

14. The system of claim 9, wherein said plurality of conductors each include a first electrical contact end and a second electrical contact end, said plurality of conductors being arranged with said first electrical contact ends disposed toward said first end of said housing in an order, said second electrical contact ends being disposed toward said second end of said housing in an other order, said order and said other order being a mirror image of each other.

15. The system of claim 14, wherein said order includes a dual staggered column of said first electrical contact ends.

16. The system of claim 9, wherein said plurality of conductors of said module receptacle coupler are configured to convey at least one of multiple line circuits, multiple neutral circuits and multiple ground circuits.

17. The system of claim 9, wherein said plurality of modular receptacles include a first modular receptacle, a second modular receptacle and a third modular receptacle, said at least one module receptacle coupler includes a first module receptacle coupler and a second module receptacle coupler, said first modular receptacle and said second modular receptacle being electrically connected by said first module receptacle coupler, said second modular receptacle and said third modular receptacle being electrically connected by said second module receptacle coupler.

18. A method of installing modular receptacles, comprising the steps of:
electrically engaging a connector end of a module receptacle coupler with a mateable end of a first modular receptacle; and
electrically engaging a mateable end of a second modular receptacle to an other connector end of said module receptacle coupler.

19. The method of claim 18, further comprising the step of connecting said first modular receptacle to one of an electrical power source and a wiring harness.

20. The method of claim 18, further comprising the step of attaching said first modular receptacle and said second modular receptacle to a wiring channel.

21. The method of claim 18, further comprising the steps of:
electrically engaging a connector end of an other module receptacle coupler with a mateable end of said second modular receptacle; and
electrically engaging a mateable end of a third modular receptacle to an other connector end of said other module receptacle coupler.
